(19) United States
(12) Patent Application Publication
(10) Pub. No.: US 2004/0195305 A1
(43) Pub. Date: Oct. 7, 2004

(54) Foldable key assembly

(76) Inventor: Leslie Dotson, Anaheim, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/716,178

(22) Filed: Nov. 19, 2003

Related U.S. Application Data
(60) Provisional application No. 60/427,913, filed on Nov. 19, 2002.

(51) Int. Cl. G06D 1/00; G06C 7/02; G06C 25/00

(52) U.S. Cl. 235/145 R

(57) ABSTRACT

A foldable keyboard assembly that is useable with several types of digital devices and software platforms. The keyboard assembly includes a keyboard and universal carriage and can be configured with multiple communication means. The keyboard assembly can be folded into a compact and durable carrying configuration and, when opened, provides an economic interface to an attached device using standard keystrokes.

### CROSS-REFERENCE TO RELATED APPLICATIONS

This application claims the benefit of U.S. Provisional Patent Application Serial No. 60/427,913, filed Nov. 19, 2002, the entirety of which is incorporated by reference as if set forth fully herein.

### BACKGROUND OF THE INVENTION

1. Field of the Invention

The present invention relates generally to keyboards and, more particularly, to foldable keyboards.

2. Background Art

Digital devices, such as personal digital assistants (PDAs), digital tablets and wireless phones, have evolved considerable capabilities while becoming increasingly smaller. Though such miniaturization is desirable from a portability perspective, it also presents drawbacks, particularly with regard to providing a means for input.

Some digital devices incorporate miniaturized keyboards. However, the key spacing on such keyboards is too small to allow for standard typing, making them inadequate for extended use. Touch screens have also been implemented and are effective for some purposes, but they too fail to match input speeds achievable with a keyboard sized for standard typing. Portable keyboards are available for some devices, such as various PDAs and digital tablets. However, such keyboards are not only inoperable with other types of digital devices but are typically platform-dependent for PDAs. For example, a portable keyboard that is designed for use with the Palm OS® platform will not work with the Pocket PC OS platform. Furthermore, current portable keyboards have ergonomic and portability shortfalls.

It should therefore be appreciated that there is a need for a foldable keyboard that is usable with various types of digital devices and platforms, is ergonomic and provides improved portability. The present invention fulfills this need as well as others.

### BRIEF SUMMARY OF THE INVENTION

The present invention provides a foldable keyboard assembly that substantially obviates one or more of the problems and disadvantages of the related art.

An embodiment of the present invention provides a foldable keyboard assembly that is useable with several types of digital devices and software platforms, such as Palm OS® PDAs, Pocket PC PDAs, digital tablets, and wireless phones. The keyboard assembly includes a keyboard and universal carriage and can be configured with multiple communication means. The keyboard assembly can be folded into a compact and durable carrying configuration and, when opened, provides an economic interface to an attached device using standard keystrokes.

Particularly, and by way of example only, one embodiment of a foldable keyboard assembly in accordance with the present invention includes an infrared (IR) rotating assembly attached to a back plate of the universal carriage and a Universal Serial Bus (USB) port having a door. The IR assembly includes a rotating stem and a foldable sensor portion and is configured without need of a mirror in the stem of the foldable portion. The keyboard assembly may further include an override circuit that inhibits the IR assembly when the door of the USB port is open.

In a particular embodiment of the present invention, the keyboard includes a hinge assembly having a locking mechanism configured to lock the keyboard open, thereby facilitating use on both even and uneven surfaces.

In another particular embodiment of the present invention, the carriage is configured to hold devices of various sizes in both portrait and landscape orientations.

In a further particular embodiment of the present invention, the foldable keyboard is operable with multiple devices and software platforms, including but not limited to Palm® PDAs, Pocket PC devices, Microsoft Windows XP® Tablet computers, and wireless phones. More particularly, the keyboard implements a combined driver usable with the multiple devices and platforms.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1A is a perspective view of a foldable keyboard assembly in accordance with an embodiment of the invention, depicting a foldable keyboard and universal carriage.

FIG. 1B is a plan view of the keyboard of the foldable keyboard assembly of FIG. 1A, depicting the key layout of the keyboard.

FIG. 2A is a perspective view of the universal carriage of the keyboard assembly of FIG. 1, depicting a spring-biased brace, a lower brace and a side brace stowed in recesses.

FIG. 2B is a partially-assembled perspective view of the universal carriage of the keyboard assembly of FIG. 1, depicting a connection path for a rotatable infrared (IR) sensor.

FIG. 3A is a right perspective view of the keyboard assembly of FIG. 1 holding a first device in a portrait orientation, the rotatable IR sensor of the keyboard assembly being aligned with an IR port located on an upper edge of the first device.

FIG. 3B is a left perspective view of the keyboard assembly of FIG. 1.

FIG. 3C is a left perspective view of the keyboard assembly of FIG. 1 holding the first device in a landscape orientation, the rotatable IR sensor of the keyboard assembly being aligned with the IR port of the first device.

FIG. 4 is a left perspective view of the keyboard assembly of FIG. 1 holding a second device, the rotatable IR sensor of the keyboard assembly being aligned with an IR port of the second device.

FIG. 5 is a right perspective view of the keyboard assembly of FIG. 1 holding a third device in a portrait orientation, the rotatable IR sensor of the keyboard assembly being aligned with an IR port located on an upper edge of the third device.

FIG. 6 is a left perspective view of the keyboard assembly of FIG. 1 holding a fourth device, the rotatable IR sensor of the keyboard assembly being aligned with an IR port located on an upper edge of the fourth device.

FIG. 7 is a close-up perspective view of a USB port door of the keyboard assembly of FIG. 1, depicting the door in a closed position.

FIG. 8 is a left perspective view of the keyboard assembly of FIG. 1 holding a fifth device in a portrait orientation, depicting the IR sensor of the keyboard assembly in a stowed position and further having a wireless communication device inserted into the USB port.

FIG. 9 is a left perspective view of the keyboard assembly of FIG. 1 holding a sixth device, depicting the universal carriage configured to support a tablet computer and a USB cable connecting the tablet computer to the keyboard assembly.

FIG. 10 includes plan and side views of the keyboard assembly of FIG. 1.

FIG. 11 includes plan and side views of a foldable keyboard assembly in accordance with an embodiment of the present invention.

FIG. 12 includes perspective views of a foldable keyboard assembly in accordance with an embodiment of the present invention.

### DETAILED DESCRIPTION OF THE INVENTION

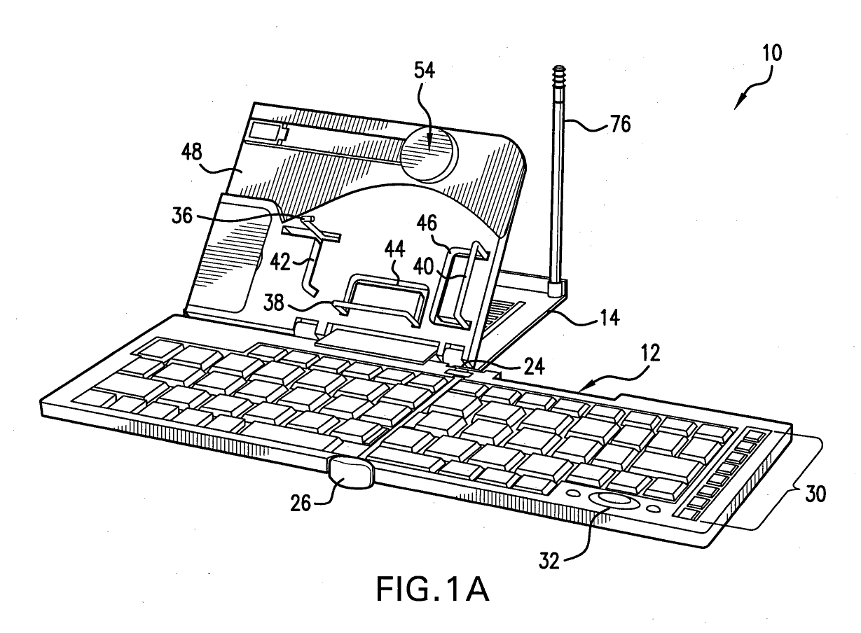

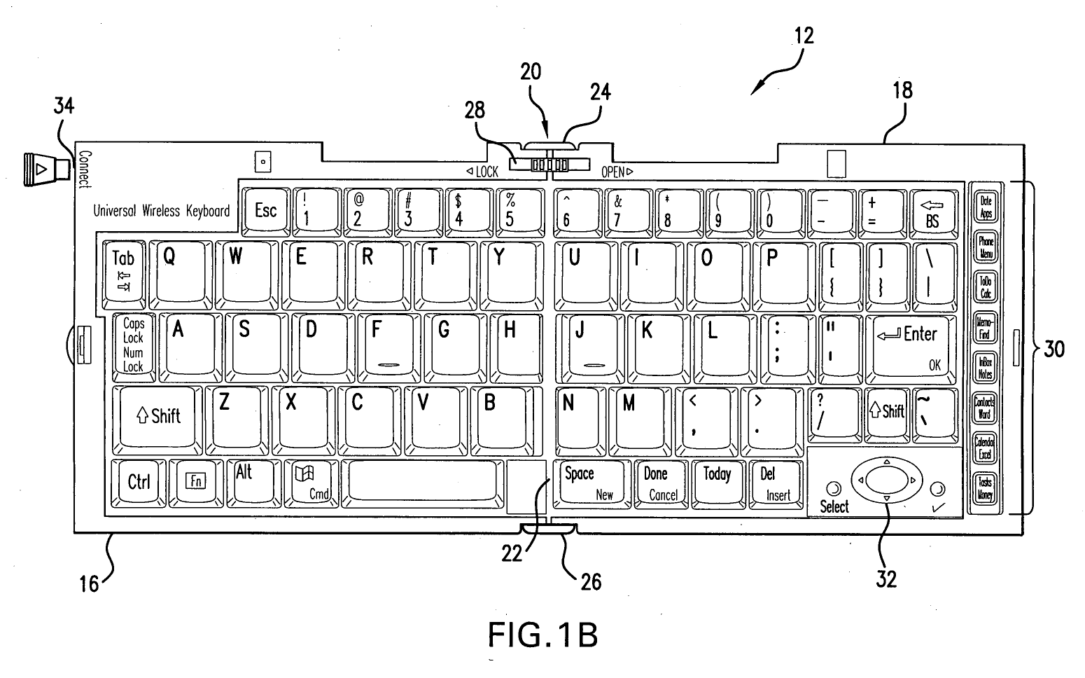

With reference to the illustrative drawings, and particularly to FIG. 1, there is shown a foldable keyboard assembly 10 in accordance with an embodiment of the present invention. Keyboard assembly 10 is adapted for use with digital devices including, but not limited to, personal digital assistants (PDAs), computers, wireless phones, and tablet computers. Keyboard assembly 10 includes a foldable keyboard 12 and a universal carriage 14 for supporting devices of various configurations and in multiple orientations. The assembly provides several options for communicating with digital devices, including a rotatable infrared (IR) sensor and a Universal Serial Bus (USB) port adapted for compatibility with cable connections as well as for wireless communication, such as wireless communication in accordance with Bluetooth® wireless technology.

With reference now to FIG. 1B, foldable keyboard 12 includes first and second segments 16, 18 attached by a hinge assembly 20 and is configured to allow for standard typing strokes. In an embodiment, keyboard 12 implements a QWERTY key pattern and, preferably, the keys are aligned such that the keyboard can be split by a generally straight gap 22. Hinge assembly 20 includes upper and lower hinges 24, 26 and a locking mechanism 28. Once keyboard 12 is open, locking mechanism 28 can be engaged to ensure that keyboard 12 remains substantially flat even when used on uneven surfaces.

In accordance with an embodiment of the invention, most of the keys have a key size of 18 mm×18 mm×3 mm and a key height of 5.1 mm. The keys may further have a key pitch of 18 mm and further include a scissor-type key switch, having a travel distance of 2.1 mm with a bound time of approximately 20 ms.

Keyboard 12 further includes function keys 30 that implement features of various PDA platforms, such as the Palm OS® or Pocket PC software platforms. For example, “data,” “phone,” “to do,” “memo,” and “inbox” function keys are provided. Keyboard 12 further includes an integrated mouse device 32 sized to be operable with one finger, and a USB port 34.

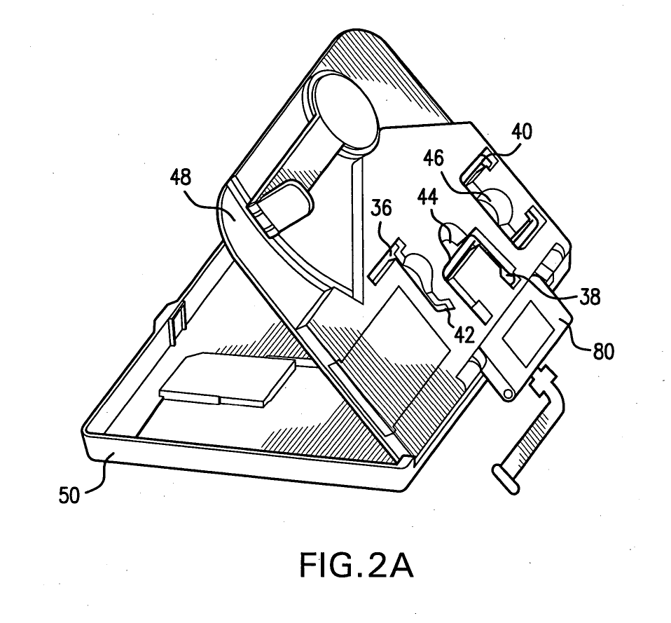

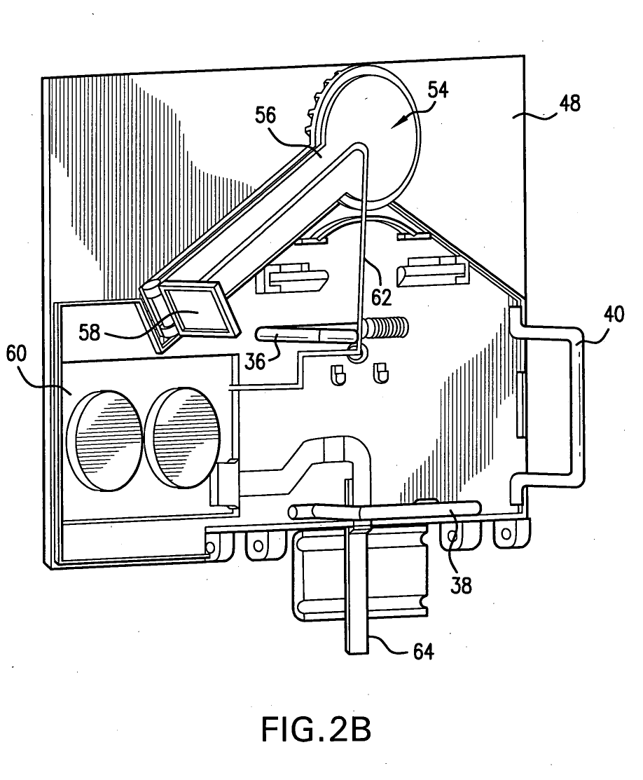

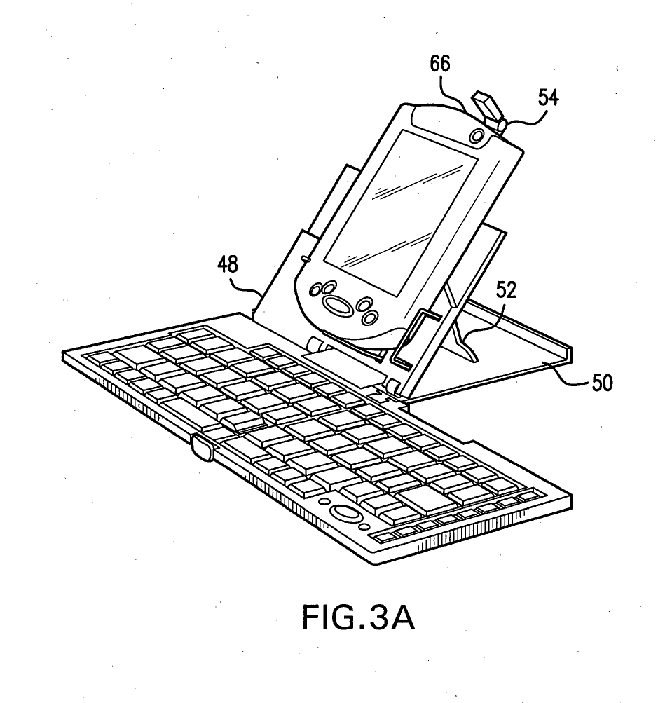

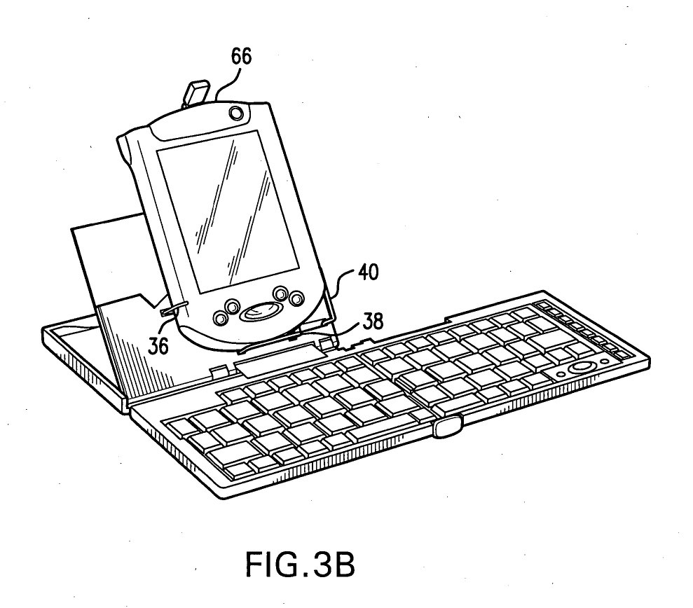

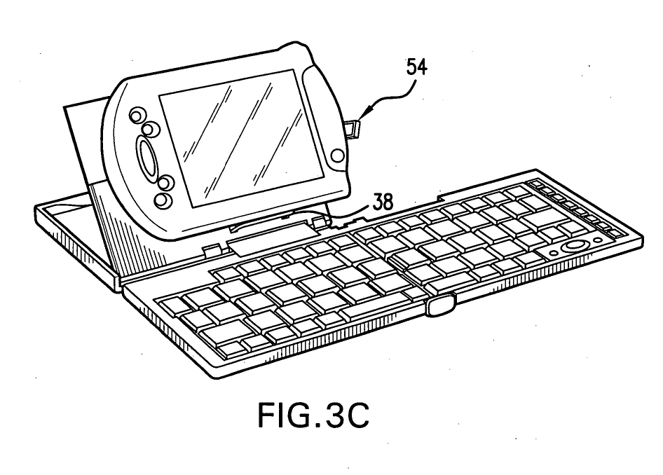

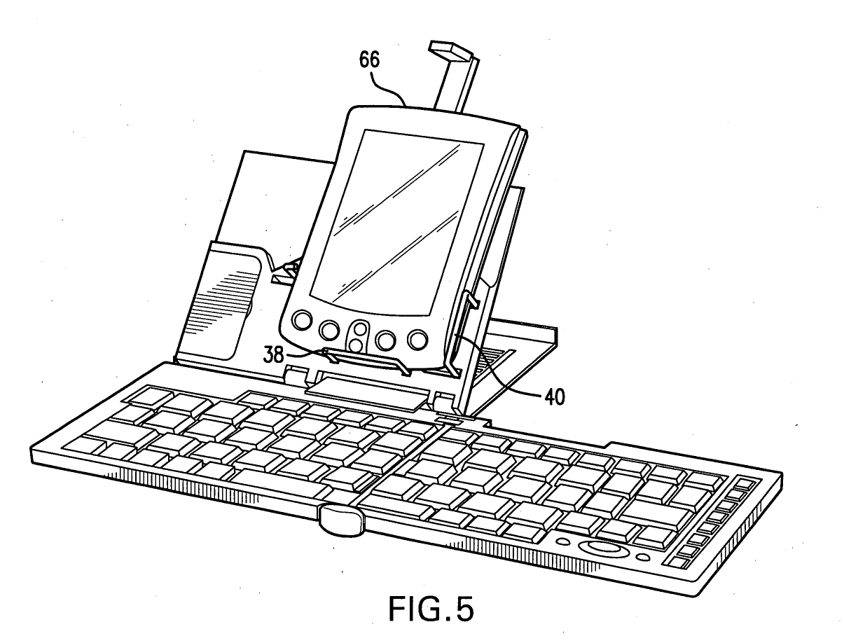

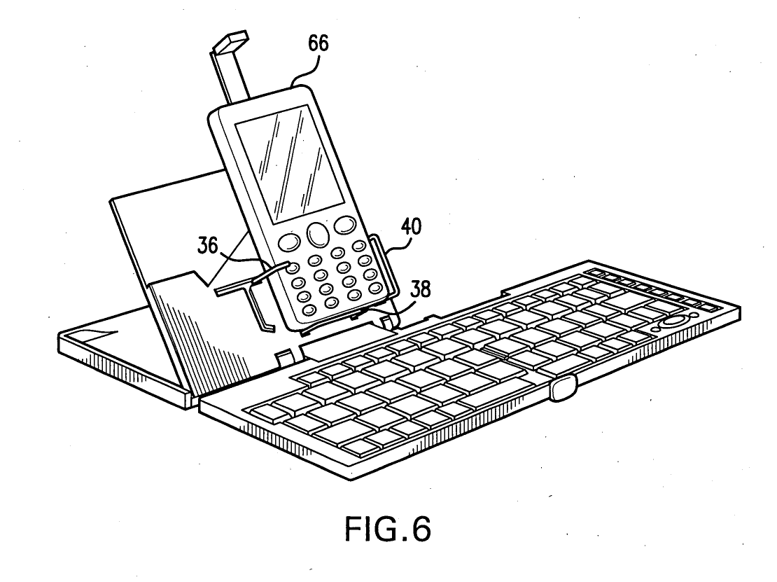

With reference now to FIGS. 2A and 2B, universal carriage 14 includes one or more support braces, including a spring-biased brace 36, a lower brace 38, a side brace 40. Universal carriage also includes recesses 42, 44, and 46 for compact storage of braces 36, 38, and 40, respectively, when not in use. By using one or more of these braces, carriage 14 can be adapted to support digital devices of various sizes, as illustrated in FIGS. 3A, 3B, 3C, and 4-6. In particular, spring-biased brace 36 is slidably adjustable to accommodate a variety of digital devices. Carriage 14 can support devices oriented in both landscape and portrait modes, as illustrated in FIGS. 3A, 3B, and 3C.

Carriage 14 includes a back plate 48, to which the braces are attached, and a top cover 50. In an open configuration, top cover 50 serves as horizontal support for back plate 48 and a support 52 (see FIG. 3) extended there between. The top cover further includes a plurality of notches (not shown), allowing for varying degrees of inclination for the back plate. Back plate 48 is connected to keyboard 12 by way of a hinge assembly 80, which permits back plate 48 to be folded onto keyboard 12 when keyboard 12 has been folded into a closed position. It is also noted that universal carriage 14 can be removed, preferably only by the manufacturer, to permit keyboard 12 to be used as a stand alone keyboard for tablet/notebook personal computers (PCs).

A rotatable IR assembly 54 is attached to back plate 48 and includes a rotating stem 56 and a foldable sensor housing 58. Foldable sensor housing 58 houses an IR sensor and is attached to rotating stem 56 by way of a hinge. As shown in FIG. 2B, the IR assembly includes an IR source 60 and a communication path 62 disposed within back plate 48. In a preferred embodiment, communication path 62 comprises copper traces, dedicated wires or flex cables. Advantageously, IR assembly 54 is configured without the need of mirrors, particularly in the rotating stem portion. A second communication path 64 extends from the IR source to keyboard 12.

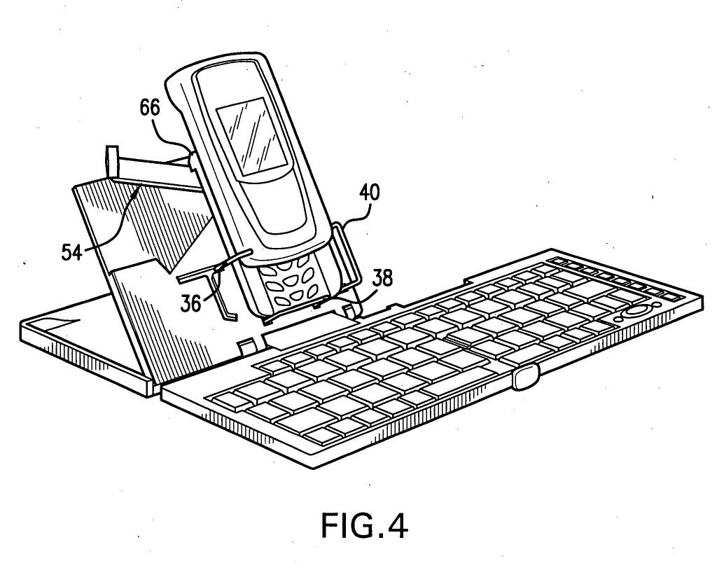

With reference now to FIGS. 3A-6, keyboard assembly 10 is useable with devices of various types, sizes, and platforms. Notably, IR assembly 54 can be rotated to align with corresponding IR ports 66, which maybe located in different positions on different digital devices. For example, an IR port 66 may be located on the top of a digital device (see FIG. 3A), on the right side of a digital device (FIG. 3B), or on the left side of a digital device (see FIG. 4). As illustrated in FIGS. 3A, 3B, 3C and 4-6, IR assembly 54 is operable at varied spacing distances from a digital device. Advantageously, due to the nature of IR communication, precise alignment between IR assembly 54 and an IR port is not required.

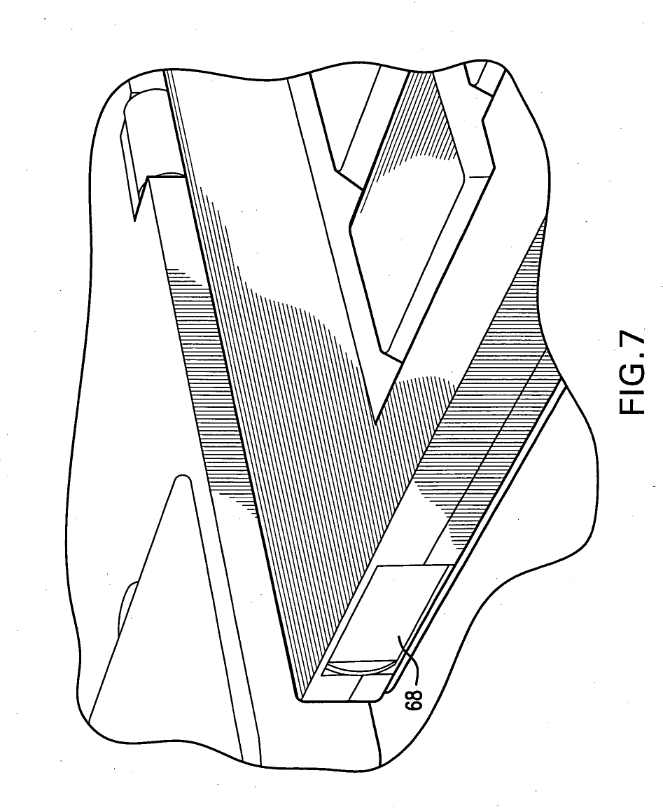

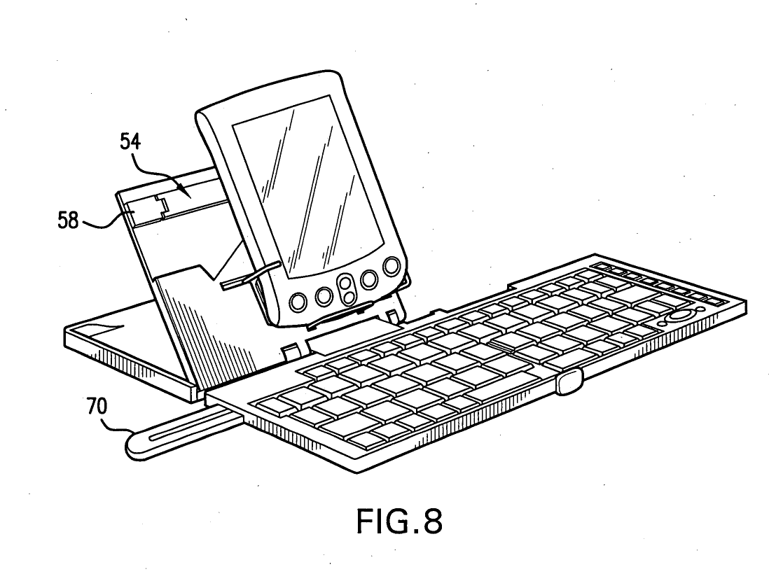

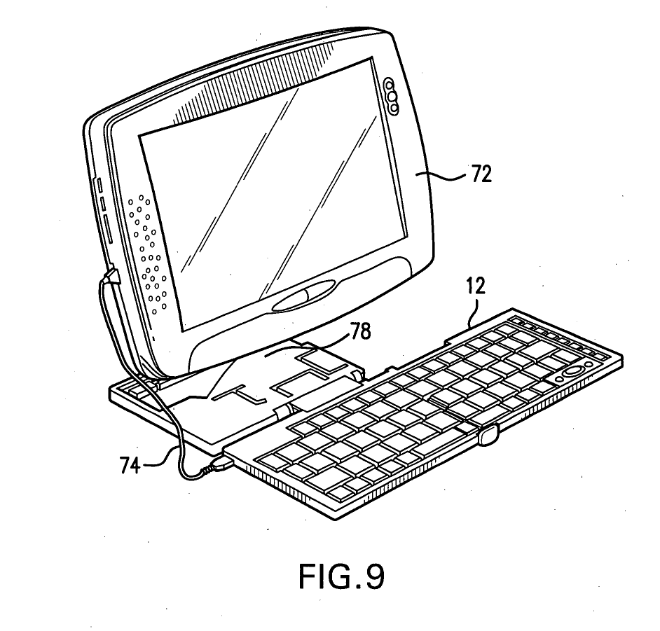

With reference now to FIGS. 7-9, keyboard assembly 10 includes a door 68 that may be closed to protect USB port 34 when the port is not in use. In an embodiment, USB door 68 is further connected to an override circuit (not shown) for IR assembly 54. Consequently, when door 68 is open, IR assembly 54 is deactivated and, when door 68 is closed, IR assembly 54 is useable. As shown in FIG. 8, keyboard assembly 10 can be used with USB-compatible wireless communication means, such as a Bluetooth® adapter 70 or other wireless network adapter. As shown in FIG. 9, keyboard assembly 10 can be used with a digital tablet 72, which is shown connected to keyboard 12 by a USB cable 74. To support tablet 72, back plate 48 is folded into top cover 50 and a second support 76 (FIG. 1A) is attached to extend vertically from carriage 14. Optionally, table 72 can be supported at a lower edge thereof by a ledge 78 of back plate 48 or by an upper edge of keyboard 12. Keyboard 12 may further include a stopper (not shown) adjacent to or integral with upper hinge 24 to support a lower edge of a digital device, thereby allowing additional clearance for IR assembly 54.

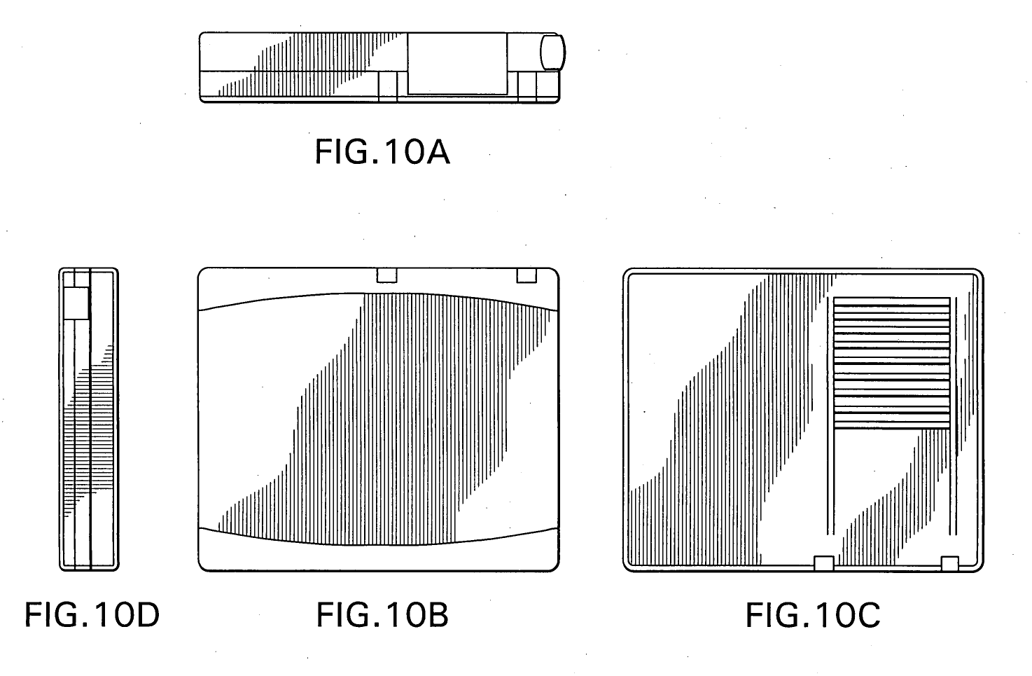

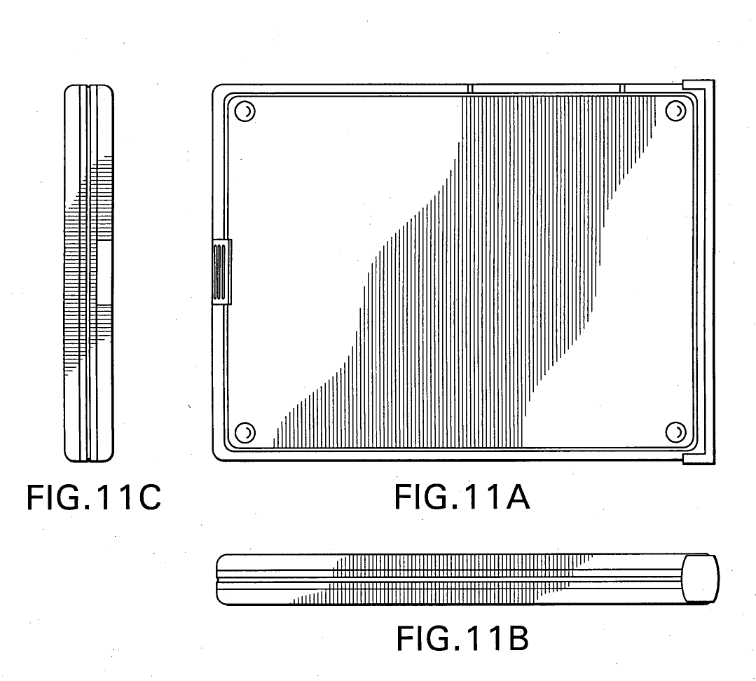

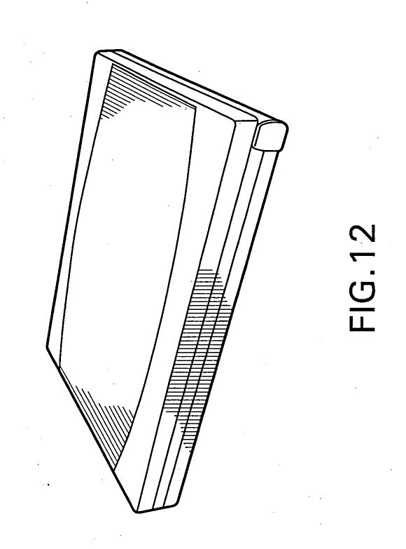

An embodiment of keyboard assembly 10 is 140 mm×104 mm×22 mm in a folded configuration and 280 mm×104 mm×6.5 mm when open. Table 1 provides various dimensions for this embodiment. FIGS. 10-12 depict several embodiments of the invention in a folded configuration. Preferably, keyboard assembly 10 has durable outer surfaces.

TABLE 1
Keyboard Assembly Dimensions

| | |
|---|---|
| dimension folded | 140 mm × 104 mm × 22 mm |
| dimension open | 280 mm × 104 mm × 6.5 mm |
| back plate | 134.5 mm × 98.5 mm × 9 mm |
| top cover | 140 mm × 104 mm × 2 mm |
| PCB space | 42.5 mm × 20.5 mm × 4.5 mm |

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A foldable keyboard assembly, comprising:
a keyboard comprising a first keyboard segment and a second keyboard segment attached thereto by a first hinge assembly, each of said first and second keyboard segments having a top portion upon which is disposed a plurality of keys and a bottom portion, said first hinge assembly permitting said first and second keyboard segments to be arranged in an open position in which said top portions of said first and second keyboard segments are exposed or in a closed position in which said top portions of said first and second keyboard segments are concealed; and
a carriage coupled to said keyboard, said carriage comprising a back plate, said back plate including a plurality of braces adapted to support a digital device communicatively coupled to said keyboard, wherein at least one of said plurality of braces is slidably adjustable to accommodate digital devices of different sizes.

2. The foldable keyboard assembly of claim 1, wherein said at least one of said plurality of braces is slidably adjustable to accommodate a personal digital assistant, a tablet computer, or a wireless phone.

3. The foldable keyboard assembly of claim 1, wherein said plurality of braces includes a spring-biased brace, a lower brace and a side brace.

4. The foldable keyboard assembly of claim 1, wherein said back plate further comprises a plurality of recesses, each one of said plurality of recesses adapted to house a corresponding one of said plurality of braces when said brace is not in use.

5. The foldable keyboard assembly of claim 1, wherein said first hinge assembly includes a locking mechanism for locking said first and second keyboard segments in said open position.

6. The foldable keyboard assembly of claim 1, wherein said back plate is coupled to said keyboard via a second hinge assembly, said second hinge assembly permitting said back plate to be folded onto said keyboard when said keyboard is in said closed position.

7. The foldable keyboard assembly of claim 1, wherein said keyboard further comprises a port adapted to receive a means for communicating with a digital device.

8. The foldable keyboard assembly of claim 7, wherein said means for communicating with a digital device comprises a Universal Serial Bus (USB) cable.

9. The foldable keyboard assembly of claim 7, wherein said means for communicating with a digital device comprises a wireless interface adapter.

10. A foldable keyboard assembly, comprising:
a keyboard comprising a first keyboard segment and a second keyboard segment attached thereto by a first hinge assembly, each of said first and second keyboard segments having a top portion upon which is disposed a plurality of keys and a bottom portion, said first hinge assembly permitting said first and second keyboard segments to be arranged in an open position in which said top portions of said first and second keyboard segments are exposed or in a closed position in which said top portions of said first and second keyboard segments are concealed; and
a carriage coupled to said keyboard, said carriage comprising
a back plate, said back plate adapted to support a digital device,
an infrared (IR) assembly attached to said back plate, said IR assembly comprising a stem and an IR sensor, said stem being rotatable to align said IR sensor with an IR port of said digital device for IR communication, and
a communication path, said communication path coupling said IR sensor to said keyboard.

11. The foldable keyboard assembly of claim 10, wherein said IR assembly further comprises a sensor housing for housing said sensor, said sensor housing being attached to said stem via a hinge.

12. The foldable keyboard assembly of claim 10, wherein said back plate comprises a plurality of braces adapted to support said digital device, wherein at least one of said plurality of braces is slidably adjustable to accommodate digital devices of different sizes.

13. The foldable keyboard assembly of claim 12, wherein said at least one of said plurality of braces is slidably adjustable to accommodate a personal digital assistant, a tablet computer, or a wireless phone.

14. The foldable keyboard assembly of claim 12, wherein said plurality of braces includes a spring-biased brace, a lower brace and a side brace.

15. The foldable keyboard assembly of claim 12, wherein said back plate further comprises a plurality of recesses, each one of said plurality of recesses adapted to house a corresponding one of said plurality of braces when said brace is not in use.

16. The foldable keyboard assembly of claim 10, wherein said first hinge assembly includes a locking mechanism for locking said first and second keyboard segments in said open position.

17. The foldable keyboard assembly of claim 10 wherein said back plate is coupled to said keyboard via a second hinge assembly, said second hinge assembly permitting said back plate to be folded onto said keyboard when said keyboard is in said closed position.

18. The foldable keyboard assembly of claim 10, wherein said keyboard further comprises a port adapted to receive a means for communicating with said digital device.

19. The foldable keyboard assembly of claim 18, wherein said means for communicating with a digital device comprises a Universal Serial Bus (USB) cable.

20. The foldable keyboard assembly of claim 18, wherein said means for communicating with a digital device comprises a wireless interface adapter.
